(19) United States
(12) Patent Application Publication
(10) Pub. No.: US 2026/0112839 A1
(43) Pub. Date: Apr. 23, 2026

(54) ANTI-ROTATION DEVICE FOR CONNECTOR HOUSING

(71) Applicant: Aptiv Technologies AG, Schaffhausen (CH)

(72) Inventors: Carlos Armando GONZALEZ DELGADILLO, Coahuila (MX); Roberto NARRO, Coahuila de Zaragoza (MX)

(21) Appl. No.: 18/967,965

(22) Filed: Dec. 4, 2024

Related U.S. Application Data
(60) Provisional application No. 63/709,686, filed on Oct. 21, 2024.

(51) Int. Cl. H01R 13/506; H01R 43/18

(52) U.S. Cl. CPC H01R 13/506; H01R 43/18

(57) ABSTRACT

The present invention discloses an anti-rotation device designed to prevent rotation of a connector housing around a connection axis. The device includes an attachment portion for securing it to the connector, which has a rotatable connector housing. Additionally, an orientation portion is provided to ensure the connector housing is aligned in a specific axial orientation along the connection axis. This innovative anti-rotation device offers a practical solution for maintaining the desired alignment of the connector housing, thereby enhancing the overall stability and functionality of the connector system.

### CROSS-REFERENCE TO RELATED APPLICATIONS

This application claims the benefit of and priority to U.S. provisional application 63/709,486, titled “Seal Retainer with a Hinged Connector Anti-Rotation Device”, filed Oct. 21, 2024, the contents of which are incorporated by reference herein.

### TECHNICAL FIELD

The subject matter disclosed herein relates to an anti-rotation device for a connector housing.

### BACKGROUND

Coaxial electrical connectors, such as subminiature version B (SMB) style connectors described by SAE USCAR Standard 17-9-2023, have a keyed connector housing that requires proper rotational alignment between mating portions of the connector. The keyed housings of existing right-angled sealed coaxial cable connector have a degree of free rotation by design. In some cases, this allows the connector to be inserted at any degree of rotation with respect to the corresponding mating connector. This rotational freedom may be a problem in application with limited packaging spaces or where the assembly operator cannot see the mating connector, since the main connector has to be manually guided in order to insert the connector with respect to the corresponding mating connector. This may allow misalignment between the connector and the corresponding mating connector keying features and delay or prevents fully mating by an assembly operator when the connector is connected with the corresponding mating connector.

Various approaches have been developed in the field of connector devices to prevent rotation of a connector housing around a connection axis. One common method involves the use of mechanical locking mechanisms that physically restrict the rotation of the connector housing. These locking mechanisms typically include protrusions, notches, or other physical features that engage with corresponding features on the connector to prevent rotation. While effective in preventing rotation, these mechanical locking mechanisms can be complex, bulky, and may require precise alignment during assembly, leading to increased manufacturing costs and potential reliability issues.

Another approach to address the issue of rotation in connector devices involves the use of friction-based anti-rotation devices. These devices rely on frictional forces between the connector housing and the attachment portion to resist rotation. While friction-based solutions can be simpler and more cost-effective compared to mechanical locking mechanisms, they may not provide a secure and reliable anti-rotation function, especially in high-vibration or high-load environments. Additionally, friction-based devices may wear over time, leading to decreased effectiveness in preventing rotation.

Furthermore, some existing anti-rotation devices utilize magnetic or electromagnetic principles to prevent rotation of connector housings. These devices typically involve the use of magnets or electromagnets to create a magnetic field that interacts with the connector housing, thereby resisting rotation. While magnetic anti-rotation devices can offer a non-contact solution that is less prone to wear and tear compared to mechanical or friction-based devices, they may require additional components and power sources, increasing complexity and cost. Additionally, magnetic solutions may not provide sufficient resistance to rotation in certain operating conditions. However, none of these approaches have provided a comprehensive solution that combines the features described in this disclosure.

### SUMMARY

In some aspects, the techniques described herein relate to an anti-rotation device, including: an attachment portion configured to attach the anti-rotation device to a connector, said connector having a connector housing which is rotatable around a connection axis of the connector; and an orientation portion configured to align the connector housing in a predetermined axial orientation along the connection axis.

In some aspects, the techniques described herein relate to a method of assembling an electrical connector, including: attaching an anti-rotation device to an electrical connector including a connector housing rotatable around a connection axis; aligning the connector housing to a predetermined radial orientation relative to the connection axis; and inserting the connector housing within a sleeve of the anti-rotation device, the sleeve being arranged to maintain the connector housing in the predetermined radial orientation relative to the connection axis.

### BRIEF DESCRIPTION OF THE DRAWINGS

FIG. 1 shows an isometric view of an electrical connector with an anti-rotation device according to some embodiments.

FIGS. 2A, 2B, and 2C show side views of a progression of the anti-rotation device in transition from an initial condition to a final condition according to some embodiments according to some embodiments.

FIG. 3 shows an isometric view of the anti-rotation device according to some embodiments.

FIG. 4A shows a top isometric view of the seal retention features of the anti-rotation device according to some embodiments.

FIG. 4B shows a close-up detail isometric view of seal retention features of the anti-rotation device according to some embodiments.

FIGS. 5A through 5E show front views of the electrical connector with the anti-rotation device in a 270°, 315°, 0°, 45°, and 90° orientation according to some embodiments.

FIG. 6 shows an isometric view of an anti-rotation device connected to an electrical connector according to some embodiments.

FIG. 7 shows an isometric view of the anti-rotation device of FIG. 6 disconnected from an electrical connector according to some embodiments.

FIG. 8A shows a front view of the anti-rotation device connected to the electrical connector of FIG. 6 according to some embodiments.

FIG. 8B shows a side view of the anti-rotation device connected to the electrical connector of FIG. 6 according to some embodiments.

FIG. 8C shows a rear view of the anti-rotation device connected to the electrical connector of FIG. 6 according to some embodiments.

FIGS. 9A through 9E shows front views of the electrical connector with the anti-rotation device in a 270°, 315°, 0°, 45°, and 90° orientation according to some embodiments.

FIG. 10 shows a flowchart of a method of assembling an electrical connector according to some embodiments.

### DETAILED DESCRIPTION

The present disclosure describes an anti-rotation device that is configured to be attached to a connector having a connector housing which is rotatable around a connection axis of the connector. The anti-rotation device is designed to hold the connector housing in a fixed axial orientation. This is especially beneficial for connector housings having keyed features that need to be aligned with corresponding keyed features in a mating connector housing. The anti-rotation device allows the connector housing to be pre-aligned with the corresponding mating connector housing, thereby reducing the need for an assembly operator to adjust the connector housing into the proper axial orientation.

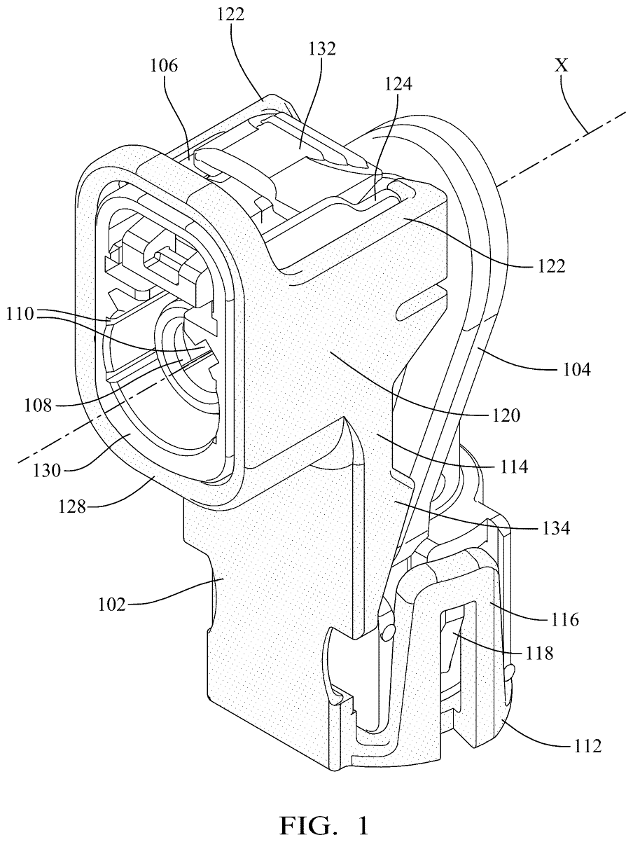

FIG. 1 is an isometric view of a nonlimiting example of an anti-rotation device 102 attached to right-angled coaxial electrical connector, hereafter referred to as the connector 104. The connector shown here is a subminiature version B (SMB) style connector as described by SAE USCAR Standard 17-9-2023. The connector 104 has a connector housing 106 surrounding the electrical terminal 108 of the connector 104 that is configured to rotate around the connection axis X of the electrical terminal 108. The connector housing 106 has a keying feature, in this example a keyed slot 110, that is configured to receive a keyed ridge of a connector housing of a corresponding mating connector (not shown). The anti-rotation device 102 has an attachment portion 112 that is configured to attach the anti-rotation device to the connector 104. In this example, the anti-rotation device 102 is connected to the connector 104 by two flexible loops 116 extending from the attachment portion 112 that engage two latches 118 on the connector 104. The anti-rotation device 102 also has an orientation portion 114 that defines a sleeve 120 in which the connector housing 106 is received to inhibit rotation of the connector housing 106 about the connection axis X A rearward end of the sleeve 120 defines a snap feature 122 configured to engage a rearward edge 124 of the connector housing 106, thereby attaching the sleeve 120 to the connector housing 106 and limiting rearward motion of the connector housing 106 relative to the sleeve 120. A forward end of the sleeve 120 defines a lip 128 configured to overlap and engage a forward edge 130 of the connector housing 106, thereby limiting forward motion of the connector housing 106 relative to the sleeve 120. The connector 104 in this example also includes a connector position assurance device, hereafter referred to as the CPA device 132. The orientation portion 114 also includes a limiting feature 134 configured to limit rearward displacement of the orientation portion 114 with respect to the connector 104.

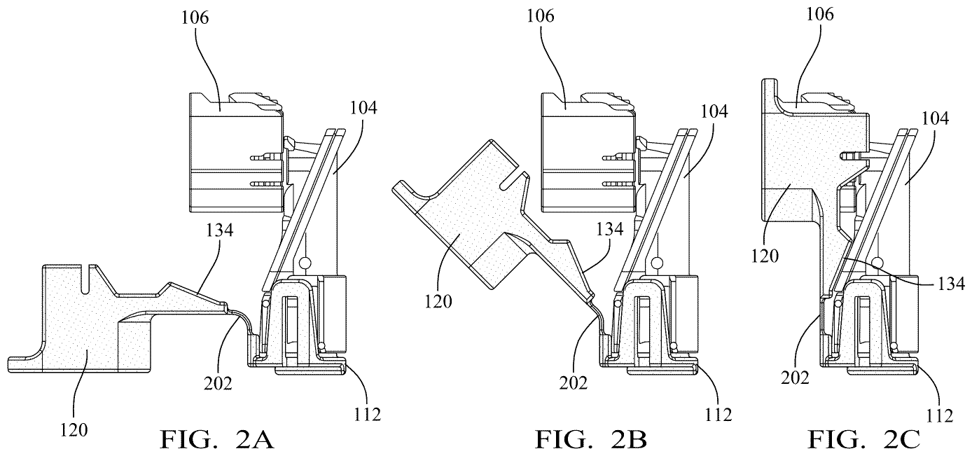

FIGS. 2A through 2C illustrate side views of the anti-rotation device 102 and connector 104 as the orientation portion 114 moves from an initial condition in which the connector housing 106 is outside of the sleeve 120 (see FIG. 2A) through an intermediate position (see FIG. 2B) to a final position in which the connector housing 106 is received within the sleeve 120 (see FIG. 2C). The attachment portion 112 is joined to the orientation portion by a hinge 202, in this example a living hinge that is integrally formed with the attachment portion 112 and the orientation portion 114.

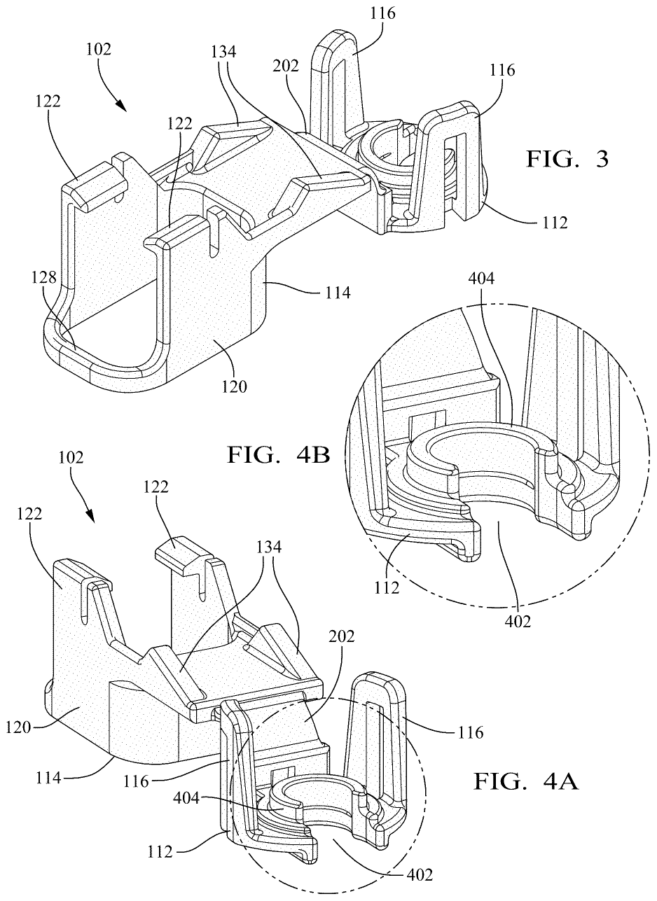

FIG. 3 shows an isometric view of the anti-rotation device 102. In FIG. 3, the snap feature 122 and lip 128 of the sleeve 120 can more clearly be seen as well as the two flexible loops 116 of the attachment portion 112.

FIG. 4A shows an alternative isometric view of the anti-rotation device 102. As can more clearly be seen in FIG. 4B, the attachment portion 112 defines a C-shaped conductor opening 402 which is configured to receive a conductor (not shown) attached to the connector. In this example, the attachment portion 112 includes a collar 404 that surrounds the conductor opening 402 and is configured to retain a seal (not shown) surrounding the conductor to the connector 104. For alterative connector designs that lack a seal, the collar 404 may be unused or omitted.

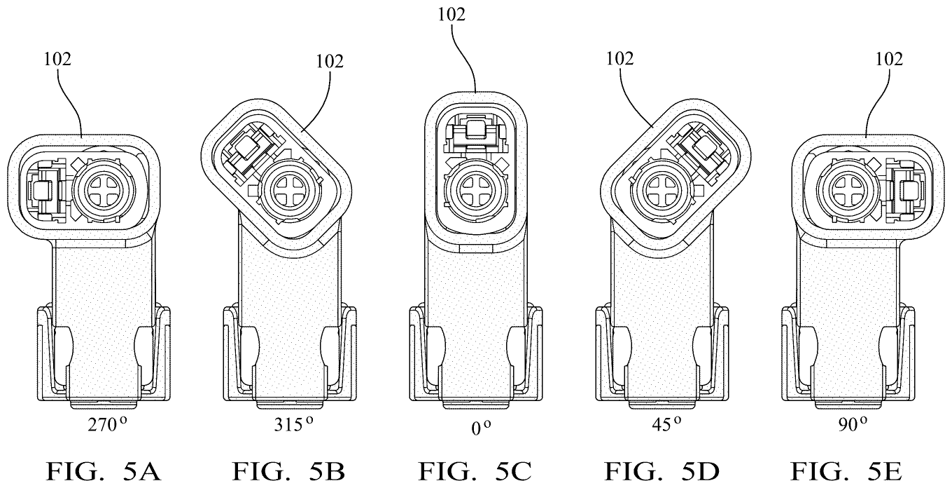

FIGS. 5A through 5E show different possible configurations of the anti-rotation device 102 configures to hold the connector 104 in a 270° orientation relative to the connector 104 (see FIG. 5A), a 315° orientation relative to the connector 104 (see FIG. 5B), a 0° orientation relative to the connector 104 (see FIG. 5C), a 45° orientation relative to the connector 104 (see FIG. 5D), and a 90° orientation relative to the connector 104 (see FIG. 5E). An anti-rotation device 102 configured to provide any other axial orientation of the connector housing 106 relative to the connector 104 may also be envisioned.

FIG. 6 is an isometric view of another nonlimiting example of an anti-rotation device 602 attached to right-angled coaxial electrical connector, hereafter referred to as the connector 604. The connector shown here is also a subminiature version B (SMB) style connector as described by SAE USCAR Standard 17-9-2023. The connector 604 has a connector housing 606 surrounding the electrical terminal 608 of the connector 604 that is configured to rotate around the connection axis X of the electrical terminal 608. The connector housing 606 has a keying feature, in this example a keyed slot 610, that is configured to receive a keyed ridge of a connector housing of a corresponding mating connector (not shown). The anti-rotation device 602 has an attachment portion 612 that defines a sleeve 614 in which the connector housing 606 is received to inhibit rotation of the connector housing 606 about the connection axis X. A rearward end of the sleeve 614 defines a snap feature 616 configured to engage a rearward edge 618 of the connector housing 606, thereby attaching the sleeve 614 to the connector housing 606 and limiting rearward motion of the connector housing 606 relative to the sleeve 614. A forward end of the sleeve 614 defines a lip 620 configured to overlap and engage a forward edge 622 of the connector housing 606, thereby limiting forward motion of the connector housing 606 relative to the sleeve 614. The anti-rotation device 602 further includes an orientation portion 624 that is integrally formed with the attachment portion 612 and fixed relative to the attachment portion 612. The connector 604 in this example also includes a connector position assurance device, hereafter referred to as the CPA device 626.

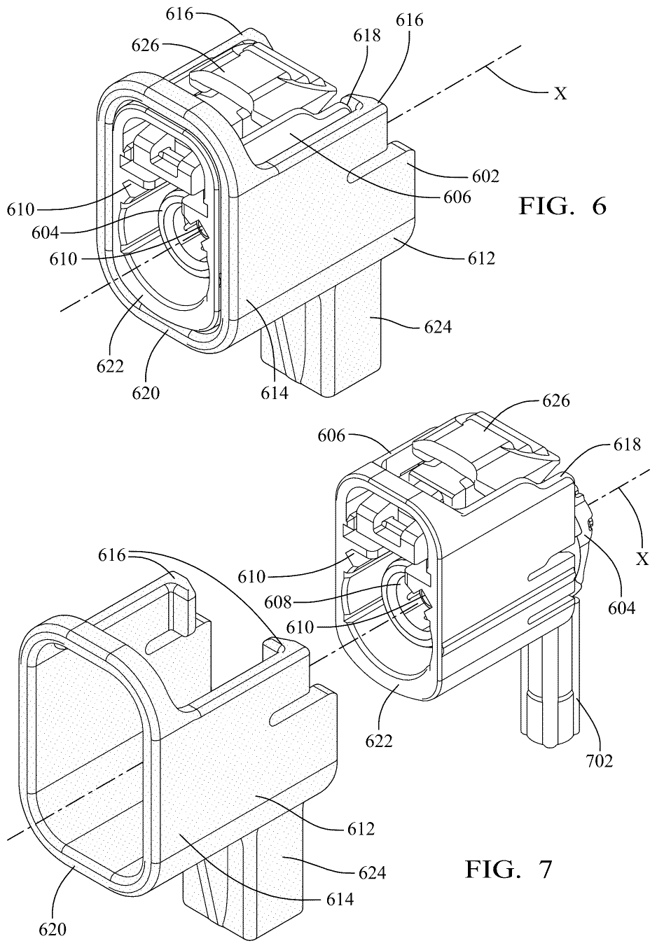

FIG. 7 shows a pre-assembly view of the anti-rotation device 602 and the connector 604 which is attached to a conductor, in this example the electrical cable 702.

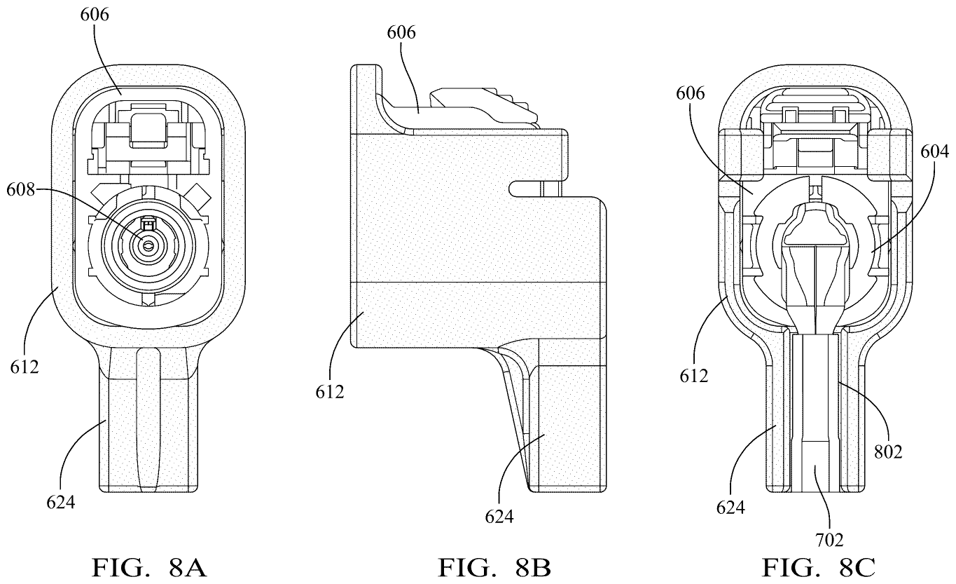

As shown in FIG. 8A to 8C, the orientation portion 624 defines a conductor channel 802 that is configured to receive the electrical cable 702 attached to the connector 604 so that the walls of the channel flank the electrical cable 702, thereby inhibiting rotation of the connector housing 606 around the connection axis X.

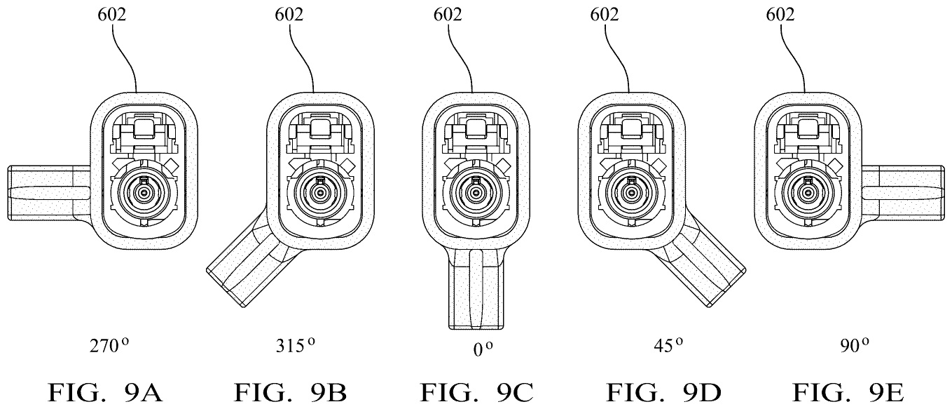

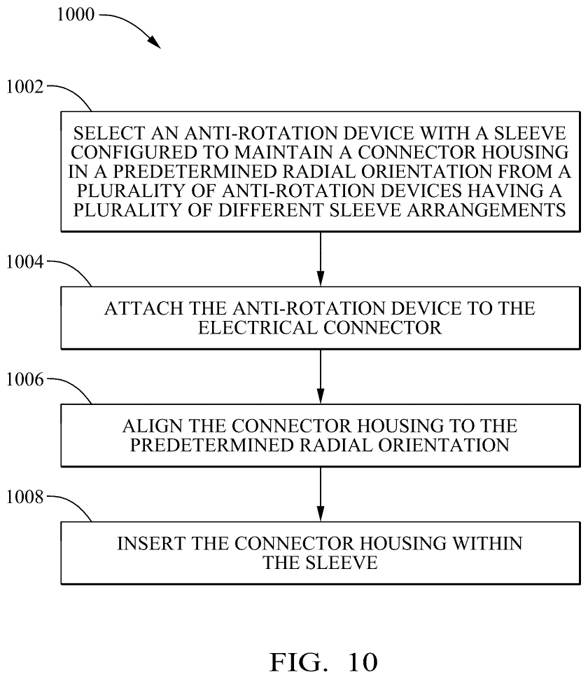

FIGS. 9A through 9E show different possible configurations of the anti-rotation device 602 configured to hold the connector 604 in a 270° orientation relative to the connector 604 (see FIG. 9A), a 315° orientation relative to the connector 604 (see FIG. 9B), a 0° orientation relative to the connector 604 (see FIG. 9C), a 45° orientation relative to the connector 604 (see FIG. 9D), and a 90° orientation relative to the connector 604 (see FIG. 9E). An anti-rotation device 602 configured to provide any other axial orientation of the connector housing 606 relative to the connector 604 may also be envisioned.

While the illustrated embodiments of the anti-rotation devices are designed for use with SMB-type connectors, other embodiments may be envisioned that are configured for use with other electrical connector types. Yet other embodiments of the anti-rotation devices may be configured for use with fiber optic connectors, pneumatic connectors, hydraulic connectors, or hybrid connectors containing a combination of any of these types of conductors.

FIG. 10 is a flowchart of a method 1000 of assembling an electrical connector, such as connectors 104 or 604 described above.

At step 1002, an anti-rotation device 102, 602 with a sleeve 120, 614 configured to maintain a connector housing 106, 606 in a predetermined radial orientation is selected from a plurality of anti-rotation devices having a plurality of different sleeve arrangements (see FIGS. 5A to 5E and 9A to 9E).

At step 1004, the anti-rotation device 102, 602 is attached to the electrical connector 104, 604. Step 1004 may include connecting an attachment portion 112, 612 of the anti-rotation device 102, 602 to the electrical connector 104, 604.

At step 1006, the connector housing 106, 606 is aligned to a predetermined radial orientation relative to the connection axis X of the electrical connector 104, 604.

At step 1008, the connector housing 106, 606 is inserted within the sleeve 120, 614 to maintain the connector housing 106, 606 in the predetermined radial orientation relative to the connection axis X. Step 1008 may include moving the sleeve 120, 614 from an initial position in which the connector housing 106, 606 is outside of the sleeve 120, 614 to a final position in which the connector housing 106, 606 is received within the sleeve 120, 614. Step 1008 may also include folding a hinge 202 connecting the attachment portion 112 to an orientation portion 114 comprising the sleeve 120 as the sleeve 120 moves from the initial position to the final position in which the connector housing 106 is received within the sleeve 120.

### Discussion of Possible Embodiments

The following are non-exclusive descriptions of possible embodiments of the present invention.

In some aspects, the techniques described herein relate to an anti-rotation device, including: an attachment portion configured to attach the anti-rotation device to a connector, said connector having a connector housing which is rotatable around a connection axis of the connector; and an orientation portion configured to align the connector housing in a predetermined axial orientation along the connection axis.

The anti-rotation device of the preceding paragraph can optionally include, additionally and/or alternatively any, one or more of the following features/steps, configurations and/or additional components.

In some aspects, the techniques described herein relate to an anti-rotation device, wherein the attachment portion is moveable relative to the orientation portion and fastened to the orientation portion by a hinge.

In some aspects, the techniques described herein relate to an anti-rotation device, wherein the hinge includes a living hinge.

In some aspects, the techniques described herein relate to an anti-rotation device, wherein the orientation portion includes a sleeve configured to surround the connector housing.

In some aspects, the techniques described herein relate to an anti-rotation device, wherein the orientation portion is moveable from an initial position in which the connector housing is outside of the sleeve to a final portion in which the connector housing is received within the sleeve.

In some aspects, the techniques described herein relate to an anti-rotation device, wherein a rearward end of the sleeve defines a snap feature configured to engage a rearward edge of the connector housing, thereby attaching the sleeve to the connector housing and limiting rearward motion of the connector housing relative to the sleeve.

In some aspects, the techniques described herein relate to an anti-rotation device, wherein a forward end of the sleeve defines a lip configured to overlap and engage a forward edge of the connector housing, thereby limiting forward motion of the connector housing relative to the sleeve.

In some aspects, the techniques described herein relate to an anti-rotation device, wherein the attachment portion includes a conductor opening configured to receive a conductor attached to the connector.

In some aspects, the techniques described herein relate to an anti-rotation device, wherein the attachment portion includes a collar surrounding the conductor opening configured to retain a seal surrounding the conductor to the connector.

In some aspects, the techniques described herein relate to an anti-rotation device, wherein the conductor opening includes a C-shaped opening.

In some aspects, the techniques described herein relate to an anti-rotation device, wherein the attachment portion is integrally formed with the orientation portion and fixed relative to the attachment portion.

In some aspects, the techniques described herein relate to an anti-rotation device, wherein the attachment portion includes a sleeve configured to surround the connector housing.

In some aspects, the techniques described herein relate to an anti-rotation device, wherein a rearward end of the sleeve defines a snap feature configured to engage a rearward edge of the connector housing, thereby attaching the sleeve to the connector housing and limiting rearward motion of the connector housing relative to the sleeve.

In some aspects, the techniques described herein relate to an anti-rotation device, wherein a forward end of the sleeve defines a lip configured to overlap and engage a forward edge of the connector housing, thereby limiting forward motion of the connector housing relative to the sleeve.

In some aspects, the techniques described herein relate to an anti-rotation device, wherein the orientation portion is configured to flank a conductor attached to the connector, thereby inhibiting rotation of the connector housing around the connection axis.

In some aspects, the techniques described herein relate to an anti-rotation device, wherein the orientation portion includes a conductor channel configured to receive a conductor attached to the connector.

In some aspects, the techniques described herein relate to a method of assembling an electrical connector, including: attaching an anti-rotation device to an electrical connector including a connector housing rotatable around a connection axis; aligning the connector housing to a predetermined radial orientation relative to the connection axis; and inserting the connector housing within a sleeve of the anti-rotation device, the sleeve being arranged to maintain the connector housing in the predetermined radial orientation relative to the connection axis.

The method of the preceding paragraph can optionally include, additionally and/or alternatively any, one or more of the following features/steps, configurations and/or additional components.

In some aspects, the techniques described herein relate to a method, further including moving the sleeve from an initial position in which the connector housing outside of the sleeve to a final position in which the connector housing is received within the sleeve. In some aspects, the techniques described herein relate to a method, further including connecting an attachment portion of the anti-rotation device to the electrical connector; and folding a hinge connecting the attachment portion to an orientation portion including the sleeve as the sleeve moves from the initial position to the final position in which the connector housing is received within the sleeve.

In some aspects, the techniques described herein relate to a method, further including selecting the anti-rotation device with the sleeve being configured to maintain the connector housing in the predetermined radial orientation from a plurality of anti-rotation devices having a plurality of different sleeve arrangements.

While an exemplary embodiment(s) has been described, it will be understood by those skilled in the art that various changes may be made, and equivalents may be substituted for elements thereof without departing from the scope of the claims. In addition, many modifications may be made to adapt a particular situation or material to the teachings of this disclosure without departing from the essential scope thereof. Therefore, it is intended that the claims are not limited to the disclosed embodiment(s) but include all embodiments falling within the scope of the following claims.

As used herein, ‘one or more’ includes a function being performed by one element, a function being performed by more than one element, e.g., in a distributed fashion, several functions being performed by one element, several functions being performed by several elements, or any combination of the above.

It will also be understood that, although the terms first, second, etc. are, in some instances, used herein to describe various elements, these elements should not be limited by these terms. These terms are only used to distinguish one element from another. For example, a first contact could be termed a second contact, and, similarly, a second contact could be termed a first contact, without departing from the scope of the various described embodiments. The first contact and the second contact are both contacts, but they are not the same contact.

The terminology used in the description of the various described embodiments herein is for the purpose of describing particular embodiments only and is not intended to be limiting. As used in the description of the various described embodiments and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Additionally, while terms of ordinance or orientation may be used herein these elements should not be limited by these terms. All terms of ordinance or orientation, unless stated otherwise, are used for purposes distinguishing one element from another, and do not denote any particular order, order of operations, direction or orientation unless stated otherwise.

1. An anti-rotation device, comprising:
an attachment portion configured to attach the anti-rotation device to a connector, said connector having a connector housing which is rotatable around a connection axis of the connector; and
an orientation portion configured to align the connector housing in a predetermined axial orientation along the connection axis.

2. The anti-rotation device in accordance with claim 1, wherein the attachment portion is moveable relative to the orientation portion and fastened to the orientation portion by a hinge.

3. The anti-rotation device in accordance with claim 2, wherein the hinge comprises a living hinge.

4. The anti-rotation device in accordance with claim 1, wherein the orientation portion comprises a sleeve configured to surround the connector housing.

5. The anti-rotation device in accordance with claim 4, wherein the orientation portion is moveable from an initial position in which the connector housing is outside of the sleeve to a final portion in which the connector housing is received within the sleeve.

6. The anti-rotation device in accordance with claim 4, wherein a rearward end of the sleeve defines a snap feature configured to engage a rearward edge of the connector housing, thereby attaching the sleeve to the connector housing and limiting rearward motion of the connector housing relative to the sleeve.

7. The anti-rotation device in accordance with claim 4, wherein a forward end of the sleeve defines a lip configured to overlap and engage a forward edge of the connector housing, thereby limiting forward motion of the connector housing relative to the sleeve.

8. The anti-rotation device in accordance with claim 1, wherein the attachment portion comprises a conductor opening configured to receive a conductor attached to the connector.

9. The anti-rotation device in accordance with claim 8, wherein the attachment portion comprises a collar surrounding the conductor opening configured to retain a seal surrounding the conductor to the connector.

10. The anti-rotation device in accordance with claim 8, wherein the conductor opening comprises a C-shaped opening.

11. The anti-rotation device in accordance with claim 1, wherein the attachment portion is integrally formed with the orientation portion and fixed relative to the attachment portion.

12. The anti-rotation device in accordance with claim 11, wherein the attachment portion comprises a sleeve configured to surround the connector housing.

13. The anti-rotation device in accordance with claim 12, wherein a rearward end of the sleeve defines a snap feature configured to engage a rearward edge of the connector housing, thereby attaching the sleeve to the connector housing and limiting rearward motion of the connector housing relative to the sleeve.

14. The anti-rotation device in accordance with claim 12, wherein a forward end of the sleeve defines a lip configured to overlap and engage a forward edge of the connector housing, thereby limiting forward motion of the connector housing relative to the sleeve.

15. The anti-rotation device in accordance with claim 12, wherein the orientation portion is configured to flank a conductor attached to the connector, thereby inhibiting rotation of the connector housing around the connection axis.

16. The anti-rotation device in accordance with claim 15, wherein the orientation portion comprises a conductor channel configured to receive the conductor attached to the connector.

17. A method of assembling an electrical connector, comprising:
attaching an anti-rotation device to an electrical connector comprising a connector housing rotatable around a connection axis;
aligning the connector housing to a predetermined radial orientation relative to the connection axis; and
inserting the connector housing within a sleeve of the anti-rotation device, the sleeve being arranged to maintain the connector housing in the predetermined radial orientation relative to the connection axis.

18. The method in accordance with claim 17, further comprising:
moving the sleeve from an initial position in which the connector housing outside of the sleeve to a final position in which the connector housing is received within the sleeve.

19. The method in accordance with claim 18, further comprising:
connecting an attachment portion of the anti-rotation device to the electrical connector; and
folding a hinge connecting the attachment portion to an orientation portion comprising the sleeve as the sleeve moves from the initial position to the final position in which the connector housing is received within the sleeve.

20. The method in accordance with claim 17, further comprising:
selecting the anti-rotation device with the sleeve being configured to maintain the connector housing in the predetermined radial orientation from a plurality of anti-rotation devices having a plurality of different sleeve arrangements
